(19) United States
(12) Patent Application Publication
(10) Pub. No.: US 2013/0212003 A1
(43) Pub. Date: Aug. 15, 2013

(54) MOBILE MONEY ORDER

(71) Applicants: Abraham Zafar, San Diego, CA (US); Bennett R. Blank, San Diego, CA (US); Miroslav Svetoslavov Boussarov, San Diego, CA (US); Sara Elizabeth Boehm, San Diego, CA (US)

(72) Inventors: Abraham Zafar, San Diego, CA (US); Bennett R. Blank, San Diego, CA (US); Miroslav Svetoslavov Boussarov, San Diego, CA (US); Sara Elizabeth Boehm, San Diego, CA (US)

(73) Assignee: INTUIT INC., Mountain View, CA (US)

(21) Appl. No.: 13/371,355

(22) Filed: Feb. 10, 2012

(51) Int. Cl. G06Q 20/08

(52) U.S. Cl. 705/39

(57) ABSTRACT

A method to track a money order transaction, including receiving, from a mobile device, a request to send the money order to a recipient, initiating, by a computer server in response to the request, a first transaction to transfer a money order amount from a funding account of the payer to a third party account held at a bank, initiating, in response to completing the first transaction, a second transaction to generate the money order by the bank, receiving, from the bank, an indication that the money order amount is paid out by the bank as a result of the recipient cashing the money order, and sending, in response to the indication, a message alerting the payer that the recipient has cashed the money order.

### BACKGROUND

A money order is a payment order for a pre-specified amount of money. Because it is required that the funds be prepaid by the payer for the amount shown on the money order, a money order is a more trusted method of payment than paying using a check. A money order typically includes two portions: the negotiable check for remittance to the payee, and a receipt or stub that the payer retains for his/her records. The payment amount of the money order is printed by machine or check writer on both portions. A similar documentation, either as a hard copy or in electronic form, is also retained at the issuer and agent locations where the money order may be purchased by the payer. In the United States, money orders are typically sold by third parties such as the United States Postal Service, grocery stores, and convenience stores.

Currently a payer who purchases a money order goes through a time consuming two step process of going to a physical location to purchase the money order and then mailing the money order to the payee. In addition, the payer may not know when and if the money order is cashed without checking with the issuer of the money order or checking with the payee.

### SUMMARY

In general, in one aspect, the invention relates to a method to track a money order transaction. The method includes receiving, from a mobile device, a request to send the money order to a recipient, wherein the request comprises a money order amount, a mailing address of the recipient, and account information of a funding account of a payer, initiating, by a processor of a computer server in response to the request, a first transaction to transfer the money order amount from the funding account of the payer to a third party account held at a bank based on the account information, initiating, by the processor in response to completing the first transaction by at least the bank, a second transaction to generate the money order by the bank, wherein the second transaction is initiated by at least transferring the money order amount from the third party account to a money order source account of the bank, wherein the money order is generated by debiting the money order amount from the money order source account and printing a money order payable to the recipient, and wherein the money order is sent to the recipient based on the mailing address, receiving, from the bank, an indication that the money order amount is paid out by the bank as a result of the recipient cashing the money order, and sending, in response to the indication, a message alerting the payer that the recipient has cashed the money order.

In general, in one aspect, the invention relates to a computer system to track a money order. The computer system includes a payer module executing on a processor of a computer server and configured to receive, from a mobile device, a request to send the money order to a recipient, wherein the request comprises a money order amount, a mailing address of the recipient, and account information of a funding account of a payer, and a bank module executing on the processor and configured to initiate, in response to the request, a first transaction to transfer the money order amount from the funding account of the payer to a third party account held at a bank based on the account information, initiate, in response to completing the first transaction by at least the bank, a second transaction to generate the money order by the bank, wherein the second transaction is initiated by at least transferring the money order amount from the third party account to a money order source account of the bank, wherein the money order is generated by debiting the money order amount from the money order source account and printing a money order payable to the recipient, and wherein the money order is sent to the recipient based on the mailing address, receive, from the bank, an indication that the money order amount is paid out by the bank as a result of the recipient cashing the money order, wherein the payer module is further configured to send, in response to the indication, a message alerting the payer that the recipient has cashed the money order.

In general, in one aspect, the invention relates to a non-transitory computer readable storage medium storing instructions for sending a money order using a mobile device of a payer. The instructions, when executed, include functionality to receive, from a mobile device, a request to send the money order to a recipient, wherein the request comprises a money order amount, a mailing address of the recipient, and account information of a funding account of a payer, initiate, by a processor of a computer server in response to the request, a first transaction to transfer the money order amount from the funding account of the payer to a third party account held at a bank based on the account information, initiate, by the processor in response to completing the first transaction by at least the bank, a second transaction to generate the money order by the bank, wherein the second transaction is initiated by at least transferring the money order amount from the third party account to a money order source account of the bank, wherein the money order is generated by debiting the money order amount from the money order source account and printing a money order payable to the recipient, and wherein the money order is sent to the recipient based on the mailing address, receive, from the bank, an indication that the money order amount is paid out by the bank as a result of the recipient cashing the money order, and send, in response to the indication, a message alerting the payer that the recipient has cashed the money order.

Other aspects of the invention will be apparent from the following detailed description and the appended claims.

### BRIEF DESCRIPTION OF DRAWINGS

FIG. 1 shows a schematic diagram of a system for mobile money order in accordance with one or more embodiments of the invention.

FIG. 2 shows a flowchart of a method for mobile money order in accordance with one or more embodiments of the invention.

FIG. 3 shows an example process flow of mobile money order in accordance with one or more embodiments of the invention.

FIGS. 4A-4E show an example of mobile money order in accordance with one or more embodiments of the invention.

FIG. 5 shows a diagram of a computer in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Embodiments of the invention provide a device, method, and user interface to purchase and send a money order using a mobile device of a payer of the money order without requiring the payer to go to a retail location to purchase the money order and then mail it. In addition, the payer receives progress messages indicating when the money order is sent, when the money order is cashed, where the money order is cashed, etc. The service for the payer to purchase and send a money order using a mobile device and to receive progress messages thereof is referred to as mobile money order service. The mobile money order service may be provided to the payer by a third party service provider separate from the bank that actually issues the money order.

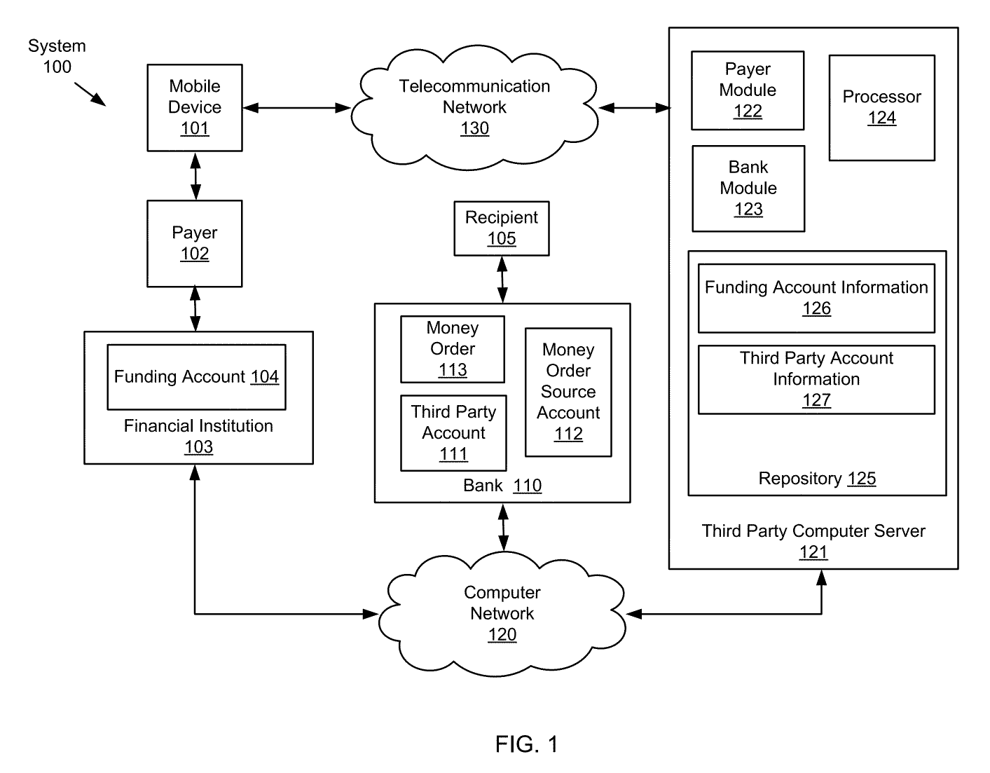

FIG. 1 depicts a schematic block diagram of a system (100) in accordance with one or more embodiments of the invention. In one or more embodiments of the invention, one or more of the modules and elements shown in FIG. 1 may be omitted, repeated, and/or substituted. Accordingly, embodiments of the invention should not be considered limited to the specific arrangements of modules shown in FIG. 1. The system (100) of FIG. 1 depicts the components of a system for mobile money order in accordance with embodiments disclosed herein.

As shown in FIG. 1, the system (100) includes a payer (102) who is a user of a mobile device (101) and has a funding account (104) held at a financial institution (103). The mobile device (101) is communicatively coupled to a third party computer server (121) via the telecommunication network (130). In one or more embodiments of the invention, the telecommunication network (130) may include mobile phone network, WIFI, or any other suitable wireless communication network. In one or more embodiments, the mobile device (101) may be a smartphone, a notebook computer, a tablet computer, or other mobile device configured with wireless communication capability. In one or more embodiments, the payer (102) uses the mobile device (101) to order a money order from a bank (110) via the third party computer server (121). In one or more embodiments, the third party computer server (121) is communicatively couple to the bank (110) and the financial institution (103) via the computer network (120). In one or more embodiments, the computer network (120) may include a private data network, a local area network, a wide area network, the Internet, and/or other types of data network. Specifically, the third party computer server (121) collects funds from the funding account (104) and in turn orders the money order from the bank (110) on behalf of the payer (102) using the third party account (111). Accordingly, the money order (113) is generated for sending to a recipient (105). Based on a money order workflow of the bank (110), an appropriate amount is set aside from the money order source account (112) when the money order (113) is generated. In one or more embodiments, the third party computer server (121) includes a payer module (122) and a bank module (123), both of which are software and/or firmware modules executing on the processor (124). In one or more embodiments, the processor (124) may be a microprocessor or any other computer circuit capable of executing software instructions. As shown in FIG. 1, the third party computer server (121) further includes the repository (125) that is configured to store funding account information (126) of the funding account (104) controlled by the payer (102) and third party account information (127) of the third party account (111) controlled by a third party service provider operating the third party computer server (121). In one or more embodiments, the repository (125) may be a disk storage device, a flash memory device, or other suitable memory or data storage device. Each module of the system (100) is described in details below.

In one or more embodiments, the payer module (122) is configured to receive, from the mobile device (101), a request to send a money order to the recipient (105). In one or more embodiments, the request includes information specifying a money order amount, a mailing address of the recipient (105), and account information of the funding account (104). Upon receiving the request, the account information of the funding account (104) is stored in the repository (125) as the funding account information (126). Generally, the funding account (104) may be any type of financial account selected by the payer (102) to pay for the money order. For example, the funding account (104) may be a prepaid money card account, a debit card account, a credit card account, a checking account, etc. held at the financial institution (103). Generally, the financial institution (103) is chosen by the payer (102) to set up one or more of these various types of accounts for managing funds of the payer (102). In one or more embodiments, the bank (110) and the third party service provider operating the third party computer server (121) may enter into a business agreement to provide the mobile money order service to the general public or to registered users. In one or more embodiments, the financial institution (103) may include the third party service provider operating the third party computer server (121). In one or more embodiments, the financial institution (103) may be the same as the bank (110). In one or more embodiments, the financial institution (103) is separate from the bank (110).

In one or more embodiments, the payer module (122) is further configured to authenticate the request based on the funding account information (126). For example, the payer module (122) may access the funding account (104) using the funding account information (126) to verify an available balance of the funding account (104). Upon successfully accessing the funding account (104) and determining that the available balance of the funding account (104) exceeds the money order amount, the payer module (122) sends an acknowledgement to the mobile device (101) confirming the request to send the money order.

In one or more embodiments, the payer module (122) may access the funding account (104) based on a pre-determined agreement between the third party service provider and the financial institution (103), which also allow the payer module (122) to request, prior to sending the acknowledgement, the financial institution (103) to place a lock on the available balance to reserve the money order amount in the funding account (104).

In one or more embodiments, the bank module (123) is configured to initiate, in response to the request, a first transaction to transfer the money order amount from the funding account (104) to the third party account (111) based on the funding account information (126). For example, the payer (102) may register to use the mobile money order service by agreeing to terms and conditions authorizing the third party computer server (121) to transfer the money order amount from the funding account (104) based on the request to send the money order.

In one or more embodiments, the bank module (123) is further configured to initiate, in response to completing the first transaction by the bank (110) and the financial institution (103), a second transaction to generate the money order (113) by the bank (110). For example, the second transaction may be initiated by at least transferring the money order amount from the third party account (111) to the money order source account (112) used by the bank (110) in its money order workflow. In a typical money order workflow, the bank (110) generates the money order (113) by debiting the money order amount from the money order source account (112) and printing the money order (113) as payable to the recipient (105). In one or more embodiments, printing the money order (113) includes physically printing a portion of the money order (113) on a physical paper. In one or more embodiments, printing the money order (113) includes generating a portion of the money order (113) in an electronic form. For example, the negotiable check for remittance to the recipient (105), and a receipt or stub that the payer (102) retains for his/her records are generally printed on physical paper, while a similar documentation retained at the bank (110) and/or the third party computer server (121) may be in electronic form. Once generated/printed, the money order (113), more specifically the negotiable check portion of the money order (113), is sent to the recipient (105) based on the mailing address of the recipient (105).

In one or more embodiments, the payer module (122) is further configured to receive, from the bank (110), an indication that the money order amount is paid out by the bank (110) as a result of the recipient (105) cashing the money order (113). Accordingly, the payer module (122) sends, in response to the indication, a message alerting the payer (102) that the recipient (105) has cashed the money order (113).

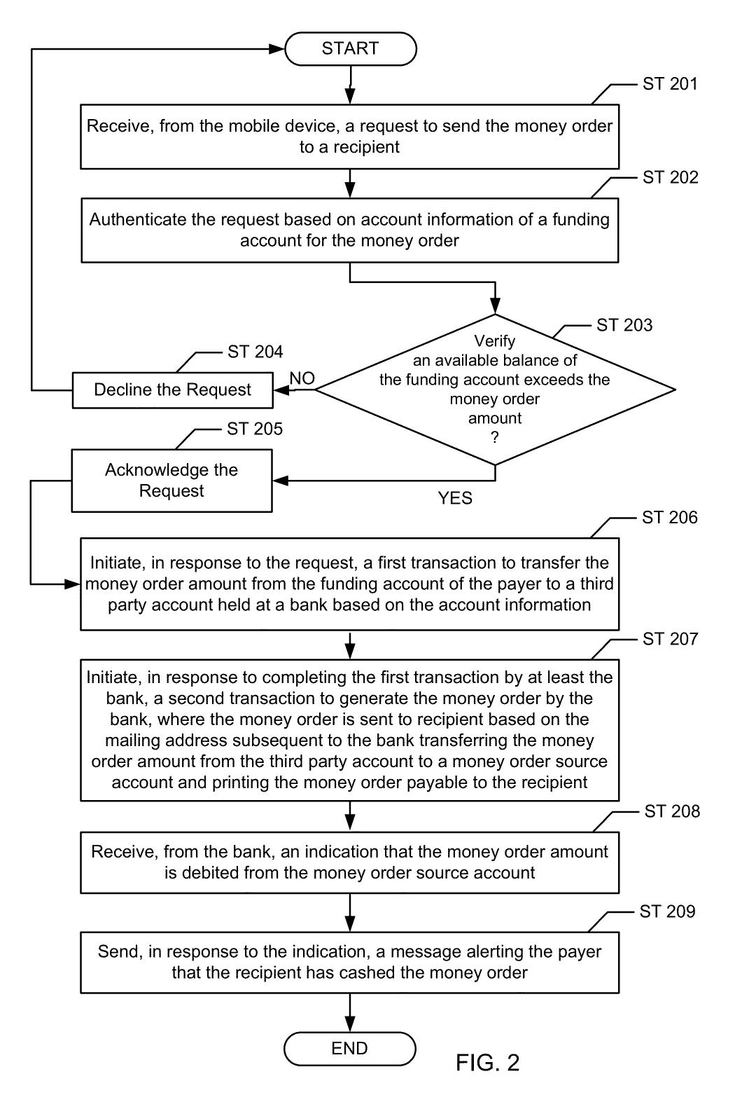

FIG. 2 depicts a flowchart of a method in accordance with one or more embodiments of the invention. In one or more embodiments of the invention, one or more of the steps shown in FIG. 2 may be omitted, repeated, and/or performed in a different order. Accordingly, embodiments of the invention should not be considered limited to the specific arrangements of steps shown in FIG. 2. In one or more embodiments, the method described in reference to FIG. 2 may be practiced using the system (100) described in reference to FIG. 1 above.

Initially in Step 201, a request is received by a computer server from a mobile device to send a money order to a recipient. For example as shown in FIG. 1, the computer server may be the third party computer server (121) and the mobile device may be the mobile device (101) used by a payer of the money order. In one or more embodiments, the request includes a money order amount, a mailing address of the recipient, and account information of a funding account of the payer to pay for the money order. For example, the funding account may be any one of a prepaid money card account, a debit card account, a credit card account, a checking account, etc. of the payer.

In Step 202, the request is authenticated based on the account information of the funding account for the money order. For example, the funding account may be accessed using the account information to confirm that it is accurate and authenticate.

In Step 203, based on a pre-determined agreement between a mobile money order service provider (e.g., the third party service provider (121) shown in FIG. 1) operating the computer server and a financial institution hosting the funding account of the payer, an available balance of the funding account is verified to have sufficient funds to pay for the money order. If the available balance is not sufficient, the request is declined in Step 204 with an alert message sent back to the mobile device alerting the payer that the account balance is insufficient and the method proceeds back to start to allow the account holder to decrease the amount of the money requested or increase the available balance of the funding account. If the available balance is verified to be sufficient, the request is acknowledged in Step 205 with an acknowledgement message sent back to the mobile device confirming the request (not shown). In one or more embodiments, based on the pre-determined agreement and prior to sending the acknowledgement, the financial institution is requested to place a lock on the available balance to reserve the money order amount for the money order. More specifically, the money order amount is reserved for a first transaction of the money order generation workflow.

In addition, if sufficient fund are verified, the method then proceeds to Step 206 where the first transaction is initiated based on the account information to transfer the money order amount from the funding account of the payer to a third party account held at a bank where the third party account is controlled by the mobile money order service provider for the purpose of providing the mobile money order service. In particular, the bank is under a business agreement to generate money order as requested by the mobile money order service provider on behalf of the payer.

In Step 207, in response to completing the first transaction by the financial institution releasing the money order amount from the funding account of the payer and the bank receiving the money order amount into the third party account of the money order service provider, a second transaction is initiated by the computer server to generate the money order by the bank. In one or more embodiments, the second transaction is part of the money order workflow at the bank and includes transferring the money order amount from the third party account to a money order source account of the bank used for generating money orders. Further, based on the money order workflow at the bank, the money order is generated by debiting the money order amount from the money order source account and printing a money order payable to the recipient of the money order. Accordingly, the money order is sent to the recipient based on the mailing address specified in the initial money order request.

In Step 208, an indication is received by computer server from the bank that the money order amount is paid out by the bank as a result of the recipient cashing the money order.

In Step 209, in response to the indication, a message is sent from the computer server to the mobile device alerting the payer that the recipient has cashed the money order. As noted above in reference to the discussion of FIG. 1, the financial institution may or may not be separate from the bank while the financial institution or the bank may include the money order service provider. In other words, the financial institution or the bank may operate the computer server to provide mobile money order service to its customers.

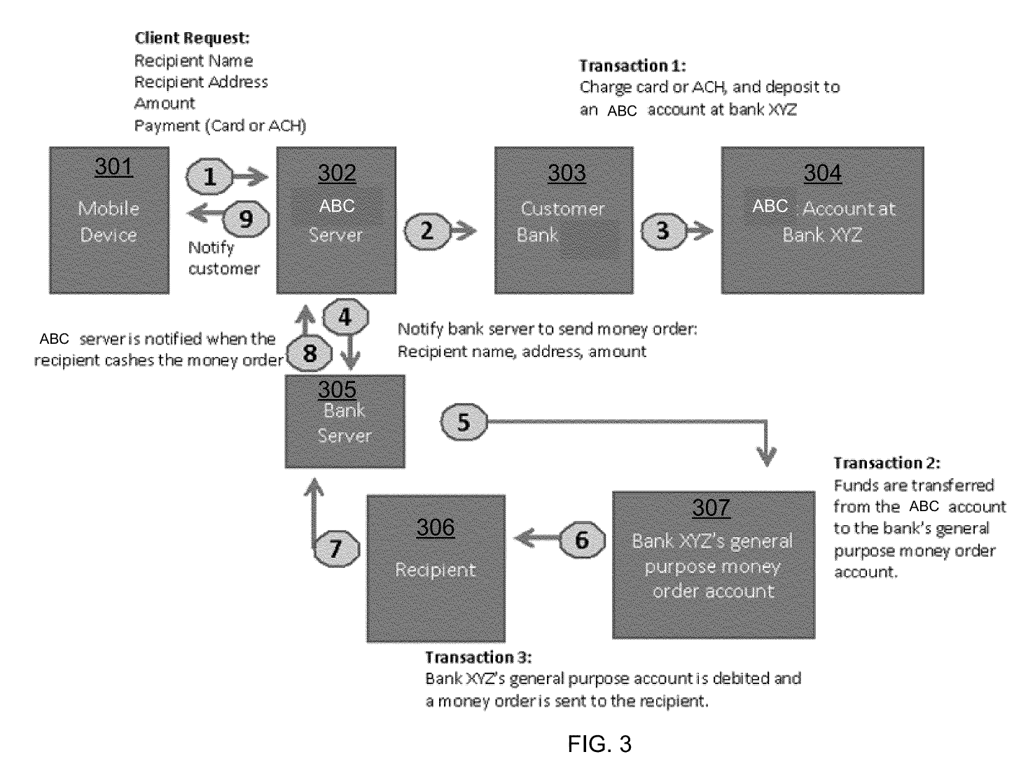

FIG. 3 shows an example process flow of mobile money order in accordance with one or more embodiments of the invention. In workflow step 1, a client/customer uses the mobile device (301) to send a mobile money order request that specifies recipient name, recipient address, money order amount, and payment method with account information (e.g., credit card, debit card, ACH, etc.). Specifically, the mobile money order request is sent to the ABC server (302) operated by the ABC mobile money order service.

In workflow step 2, the ABC server (302) initiates transaction 1 that charges the credit/debit card account of the customer held at the customer bank (303) and deposits the charged amount (i.e., face amount for the money order plus applicable fees) into ABC account (304) at bank XYZ. Workflow step 3 represents completion of transaction 1. In this example, the ABC account is controlled by the ABC mobile money order service for the purpose of providing mobile money order service to its users. In addition, ABC mobile money order service and Bank XYZ has entered into a business agreement regarding activities involved in providing the mobile money order service.

In workflow step 4, with the funds from the customer secured in the ABC account, the ABC server notifies the bank server (305) of the bank XYZ to send the money order based on the recipient name, address, and the money order amount. Accordingly, in workflow step 5, the money order amount is transferred in transaction 2 from the ABC account to bank XYZ's general purpose money order account (307), which is essentially the money order source account (112) shown in FIG. 1.

In workflow step 6, transaction 3 is performed to debit bank XYZ's general purpose money order account (307) and print/send the money order to the recipient (306). At some point in time, the recipient (306) cashes the money order as represented as workflow step 7. When the cashed money order returns to bank XYZ, the bank server (305) of the bank XYZ notifies the ABC server in workflow step 8 that the recipient (306) has cashed the money order.

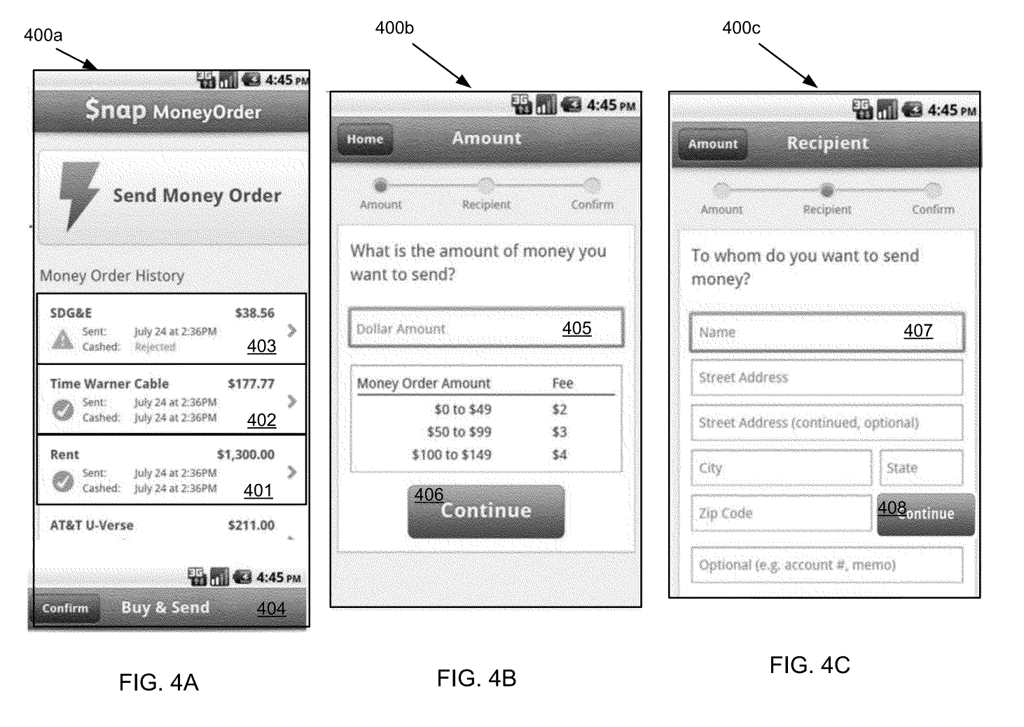

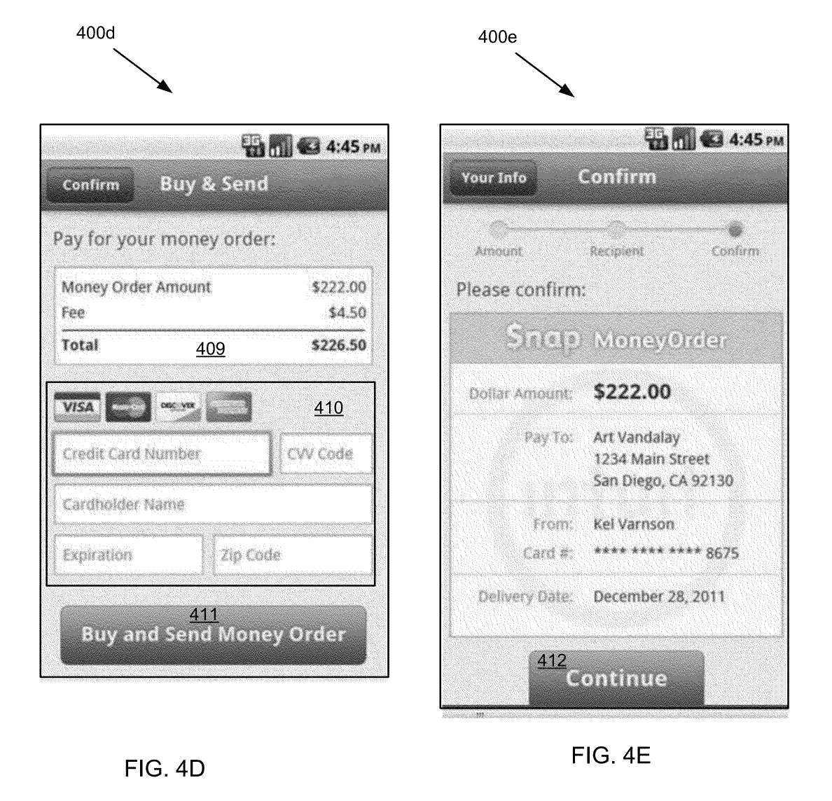

FIGS. 4A-4E show an example of mobile money order in accordance with one or more embodiments of the invention. This example application may be practiced using the system (100) of FIG. 1 and based on the method described with respect to FIG. 2 above.

In the example depicted in FIGS. 4A-4E, Kel Varnson is a user of mobile money order service “$nap MoneyOrder” and is using his smartphone to send a money order to his friend Art Vandalay. Initially, Kel has registered with “$nap MoneyOrder” and agreed to the terms and conditions of using the service. Accordingly, Kel has also downloaded and installed the mobile money order application “$nap MoneyOrder” onto his smartphone.

FIG. 4A shows screenshot 400a of Kel's smartphone when he activates the mobile money order application “$nap MoneyOrder”. Screenshot 400a is the home page of the mobile money order application “$nap MoneyOrder” showing a history of money orders that Kel has sent before, using “$nap MoneyOrder”. For example, item (401) and item (402) show money orders sent to pay for rent and cable service, respectively that are cashed. Item (403) shows a money order sent but is rejected when an attempt was made to cash it, possibly due to expiration or fraudulent use of the money order. Screenshot (400a) also includes command button (404) that allows Kel to request a new money order. When Kel clicks the command button (404), “$nap MoneyOrder” proceeds to the next screen shown in FIG. 4B.

FIG. 4B shows screenshot 400b of Kel's smartphone allowing him to enter the dollar amount of the money order in the input field (405) and then clicking the command button (406) to proceed to the next screen shown in FIG. 4C. In addition, a processing fee schedule is also included in the screenshot (400b) for easy reference.

FIG. 4C shows screenshot (400c) of Kel's smartphone allowing him to enter the information of the money order recipient. For example, Kel may enter recipient name “Art Vandalay” into the input field (407) and other pertinent information then click the command button (408) to proceed to the next screen shown in FIG. 4D.

FIG. 4D shows screenshot (400d) of Kel's smartphone allowing him to enter payment account information to pay for the money order. The information field (409) shows total amount of payment including the face value of the money order plus applicable fees. The input field (410) allows Kel to select a payment method and to enter the relevant payment account information. Once completed, Kel clicks the command button (411) to proceed to the next screen shown in FIG. 4E.

FIG. 4E shows screenshot (400e) of Kel's smartphone when he is asked to confirm the information (i.e., money order amount, recipient name and mailing address, payment account information, etc.) of the money order based on his inputs in the previous steps. The estimated delivery date of the money order may also be determined based on the processing requirement of the bank issuing the money order as well as the mailing time estimated based on the recipient mailing address. Once reviewed for accuracy and accepting the estimated delivery date, Kel clicks the command button (412) to confirm his request of the money order and authorizes the mobile money order service “$nap MoneyOrder” to charge his payment account, purchase the money order from the issuing bank, and mail the money order to the recipient. Some time later, when Art Vandalay receives and successfully cashes the money order, Kel's smartphone will receive an alert message (e.g., a text message or an email) and the home page of the mobile money order application “$nap MoneyOrder” will be updated accordingly.

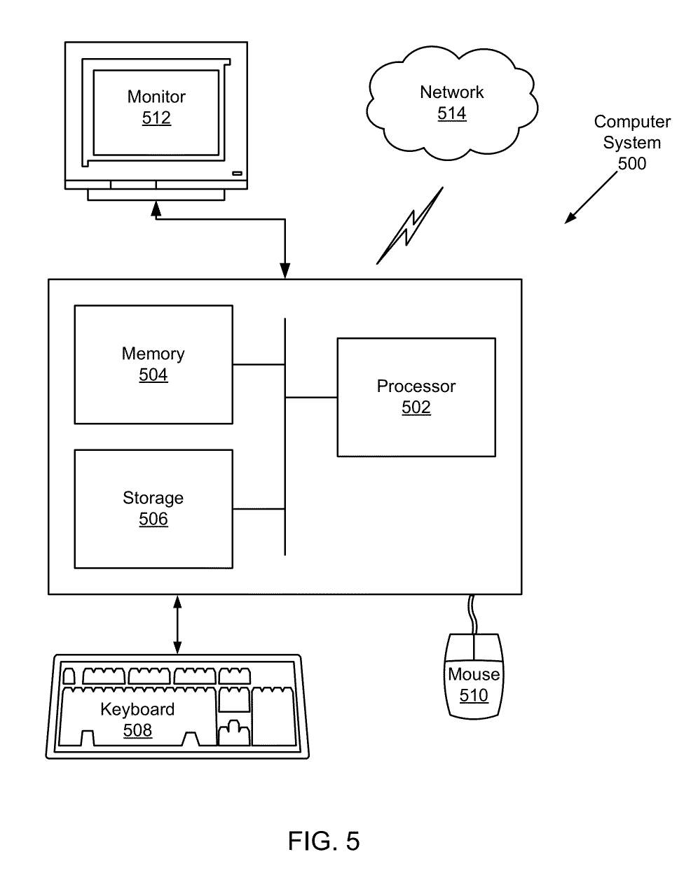

Embodiments of the invention may be implemented on virtually any type of computer regardless of the platform being used. For example, as shown in FIG. 5, a computer system (500) includes one or more processor(s) (502) such as a central processing unit (CPU), integrated circuit, or other hardware processor, associated memory (504) (e.g., random access memory (RAM), cache memory, flash memory, etc.), a storage device (506) (e.g., a hard disk, an optical drive such as a compact disk drive or digital video disk (DVD) drive, a flash memory stick, etc.), and numerous other elements and functionalities typical of today's computers (not shown). The computer system (500) may also include input means, such as a keyboard (508), a mouse (510), or a microphone (not shown). Further, the computer system (500) may include output means, such as a monitor ((512) (e.g., a liquid crystal display (LCD), a plasma display, or cathode ray tube (CRT) monitor). The computer system (500) may be connected to a network (514) (e.g., a local area network (LAN), a wide area network (WAN) such as the Internet, or any other similar type of network)) with wired and/or wireless segments via a network interface connection (not shown). Those skilled in the art will appreciate that many different types of computer systems exist, and the aforementioned input and output means may take other forms. Generally speaking, the computer system (500) includes at least the minimal processing, input, and/or output means necessary to practice embodiments of the invention.

Further, those skilled in the art will appreciate that one or more elements of the aforementioned computer system (500) may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions for performing embodiments of the invention may be stored on a non-transitory computer readable storage medium such as a compact disc (CD), a diskette, a tape, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method to track a money order transaction, comprising:
receiving, from a mobile device, a request to send the money order to a recipient, wherein the request comprises a money order amount, a mailing address of the recipient, and account information of a funding account of a payer;
initiating, by a processor of a computer server in response to the request, a first transaction to transfer the money order amount from the funding account of the payer to a third party account held at a bank based on the account information;
initiating, by the processor in response to completing the first transaction by at least the bank, a second transaction to generate the money order by the bank,
wherein the second transaction is initiated by at least transferring the money order amount from the third party account to a money order source account of the bank,
wherein the money order is generated by debiting the money order amount from the money order source account and printing a money order payable to the recipient, and
wherein the money order is sent to the recipient based on the mailing address;
receiving, from the bank, an indication that the money order amount is paid out by the bank as a result of the recipient cashing the money order; and
sending, in response to the indication, a message alerting the payer that the recipient has cashed the money order.

2. The method of claim 1, wherein the computer server is operated by a third party service provider controlling the third party account held at the bank.

3. The method of claim 2, further comprising:
authenticating the request based on the account information of the funding account;
verifying, based on a pre-determined agreement between the third party service provider and an financial institution hosting the funding account of the payer, an available balance of the funding account; and
sending, in response to determining that the available balance of the funding account exceeds the money order amount, an acknowledgement to the mobile device confirming the request to send the money order.

4. The method of claim 3, further comprising:
requesting, based on the pre-determined agreement and prior to sending the acknowledgement, the financial institution to place a lock on the available balance to reserve the money order amount for the first transaction.

5. The method of claim 1, wherein the funding account is associated with at least one selected from a group consisting of a prepaid money card account, a debit card account, a credit card account, and a checking account.

6. The method of claim 3, wherein the financial institution is separate from the bank.

7. The method of claim 3, wherein the financial institution comprises the third party service provider.

8. A computer system to track a money order, comprising:
a payer module executing on a processor of a computer server and configured to receive, from a mobile device, a request to send the money order to a recipient, wherein the request comprises a money order amount, a mailing address of the recipient, and account information of a funding account of a payer; and
a bank module executing on the processor and configured to:
initiate, in response to the request, a first transaction to transfer the money order amount from the funding account of the payer to a third party account held at a bank based on the account information;
initiate, in response to completing the first transaction by at least the bank, a second transaction to generate the money order by the bank,
wherein the second transaction is initiated by at least transferring the money order amount from the third party account to a money order source account of the bank,
wherein the money order is generated by debiting the money order amount from the money order source account and printing a money order payable to the recipient, and
wherein the money order is sent to the recipient based on the mailing address;
receive, from the bank, an indication that the money order amount is paid out by the bank as a result of the recipient cashing the money order,
wherein the payer module is further configured to send, in response to the indication, a message alerting the payer that the recipient has cashed the money order.

9. The computer server of claim 8, wherein the computer server is operated by a third party service provider controlling the third party account held at the bank.

10. The computer system of claim 9, wherein the payer module is further configured to:
authenticate the request based on the account information of the funding account;
verify, based on a pre-determined agreement between the third party service provider and an financial institution hosting the funding account of the payer, an available balance of the funding account; and
send, in response to determining that the available balance of the funding account exceeds the money order amount, an acknowledgement to the mobile device confirming the request to send the money order.

11. The computer system of claim 10, wherein the payer module is further configured to:
request, based on the pre-determined agreement and prior to sending the acknowledgement, the financial institution to place a lock on the available balance to reserve the money order amount for the first transaction.

12. The computer system of claim 8, wherein the funding account is associated with at least one selected from a group consisting of a prepaid money card account, a debit card account, a credit card account, and a checking account.

13. The computer system of claim 10, wherein the financial institution is separate from the bank.

14. The computer system of claim 10, wherein the financial institution comprises the third party service provider.

15. A non-transitory computer readable storage medium comprising instructions for sending a money order using a mobile device of a payer, that when executed, comprise functionality to:
receive, from a mobile device, a request to send the money order to a recipient, wherein the request comprises a money order amount, a mailing address of the recipient, and account information of a funding account of a payer;
initiate, by a processor of a computer server in response to the request, a first transaction to transfer the money order amount from the funding account of the payer to a third party account held at a bank based on the account information;
initiate, by the processor in response to completing the first transaction by at least the bank, a second transaction to generate the money order by the bank,
wherein the second transaction is initiated by at least transferring the money order amount from the third party account to a money order source account of the bank,
wherein the money order is generated by debiting the money order amount from the money order source account and printing a money order payable to the recipient, and
wherein the money order is sent to the recipient based on the mailing address;
receive, from the bank, an indication that the money order amount is paid out by the bank as a result of the recipient cashing the money order; and
send, in response to the indication, a message alerting the payer that the recipient has cashed the money order.

16. The non-transitory computer readable storage medium of claim 15, wherein the computer server is operated by a third party service provider controlling the third party account held at the bank.

17. The non-transitory computer readable storage medium of claim 16, the instructions, when executed, comprise functionality to:
authenticate the request based on the account information of the funding account;
verify, based on a pre-determined agreement between the third party service provider and an financial institution hosting the funding account of the payer, an available balance of the funding account;
send, in response to determining that the available balance of the funding account exceeds the money order amount, an acknowledgement to the mobile device confirming the request to send the money order; and
request, based on the pre-determined agreement and prior to sending the acknowledgement, the financial institution to place a lock on the available balance to reserve the money order amount for the first transaction.

18. The non-transitory computer readable storage medium of claim 15, wherein the funding account is associated with at least one selected from a group consisting of a prepaid money card account, a debit card account, a credit card account, and a checking account.

19. The non-transitory computer readable storage medium of claim 17, wherein the financial institution is separate from the bank.

20. The non-transitory computer readable storage medium of claim 17, wherein the financial institution comprises the third party service provider.
